(19) United States
(12) Patent Application Publication
(10) Pub. No.: US 2026/0023838 A1
(43) Pub. Date: Jan. 22, 2026

(54) System and Method for Pre-Authenticating and Processing Interaction Data Associated with a Software Application

(71) Applicant: Bank of America Corporation, Charlotte, NC (US)

(72) Inventors: George A. Albero, Charlotte, NC (US); Naga Vamsi Krishna Akkapeddi, Charlotte, NC (US)

(21) Appl. No.: 18/776,464

(22) Filed: Jul. 18, 2024

(51) Int. Cl. G06F 21/44

(52) U.S. Cl. CPC G06F 21/44

(57) ABSTRACT

A method is provided that includes receiving, on an entity server, an onboarding request from a first software application. The method includes determining whether the first software application has previously been approved to communicate with software applications by comparing identification data associated with the first software application to the identification data associated with a first set of trusted software applications. The method comprises determining whether the first software application has previously communicated with the first set of trusted software applications by comparing the historical communication data associated with the first software application to the historical communication data associated with the first set of trusted software applications. The method further comprises pre-authenticating the first software application to allow the first software application to communicate interaction data to the software applications, processing interaction data using the software applications to generate pre-authenticated data, and storing the pre-authenticated data in the memory.

### TECHNICAL FIELD

This disclosure generally relates to network communications and information security. More particularly, this disclosure relates to a system and method for pre-authenticating and processing interaction data associated with a software application.

### BACKGROUND

Entity servers may perform various operations on interaction requests before recording and posting the interaction. For example, the entity server may perform validations, processing, and recording.

### SUMMARY

When a new software application or device associated with a new product or service is launched with the intent of integrating the new software application or device into an entity server's workflow of existing software applications, there are certain instances where the new software application or device should be onboarded before being allowed to communicate with existing upstream and/or downstream software applications in the entity server. One technical problem associated with onboarding the new software application or device is that onboarding takes time to be completed, and in certain instances, the existing software applications are not allowed to communicate with the new software application or device until onboarding is completed.

The system and method described in the present disclosure provide practical applications and technical advantages that overcome the current technical problems described herein. First, the provided system and method allow for the new software applications or devices to be pre-authenticated before formal onboarding to allow the new software application or device to communicate interaction data to the entity server. For example, once pre-authenticated and approved for communication, the entity server may perform various operations (e.g., validations, data enrichment, etc.) so that the interaction data can be processed and made ready for posting while the new software applications or devices are being onboarded. In one embodiment, pre-authenticating the new software applications or devices in real-time (or near real-time) provides the practical application and technical advantage of improving the underlying technology by increasing efficiency of the system because the interaction data can be processed prior to formal onboarding. Second, the provided system and method may improve network security by utilizing a secure multi-party computation engine to pre-authenticate the new software applications or devices. For example, the secure multi-party computation engine may contain a first set of trusted applications and a second set of trusted software applications. The provided system and method may pre-authenticate the new software applications or devices if the entity server determines that the new software applications or devices have communicated with the first set of trusted applications in the past, or if the identity of the new software applications or devices can be confirmed by the second set of trusted software applications. The secure multi-party computation engine in the entity server may utilize a cryptographic protocol during this process such that the data shared between the applications or devices and the entity server is encrypted, thereby improving network security.

In one embodiment, the present disclosure provides an entity server comprising a memory operable to store a plurality of software applications configured to manage interaction data, known identification data associated with a first set of trusted software applications that are approved to communicate with the plurality of software applications, and historical communication data associated with the first set of trusted software applications. The entity server comprises a processor operably coupled to the memory. The processor is configured to receive an onboarding request from a first software application, wherein the onboarding request includes a request to communicate between the first software application and the plurality of software applications. The onboarding request comprises identification data associated with the first software application and historical communication data associated with the first software application. The processor is configured to determine whether the first software application has previously been approved to communicate with the plurality of software applications by comparing the identification data associated with the first software application to the identification data associated with the first set of trusted software applications. In response to determining that the first software application has previously communicated with one or more of the first set of trusted software applications, the processor is configured to pre-authenticate the first software application to allow the first software application to communicate an interaction request to the plurality of software applications, wherein the interaction request comprises the interaction data. The processor is configured to process the interaction data using the plurality of software applications to generate pre-authenticated data and store the pre-authenticated data in the memory.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system according to an embodiment of the present disclosure; and

FIG. 2 illustrates a flowchart of a method according to an embodiment of the present disclosure.

### DETAILED DESCRIPTION

The provided entity server of the present disclosure is configured to allow new software applications or devices to be pre-authenticated to allow the new software applications or devices to communicate data to the entity server prior to formal onboarding. Once pre-authenticated for communication, the entity server may perform various operations (e.g., validations, data enrichment, etc.) so that the interaction data can be processed and made ready for posting while the new software applications or devices are being onboarded.

### System Overview

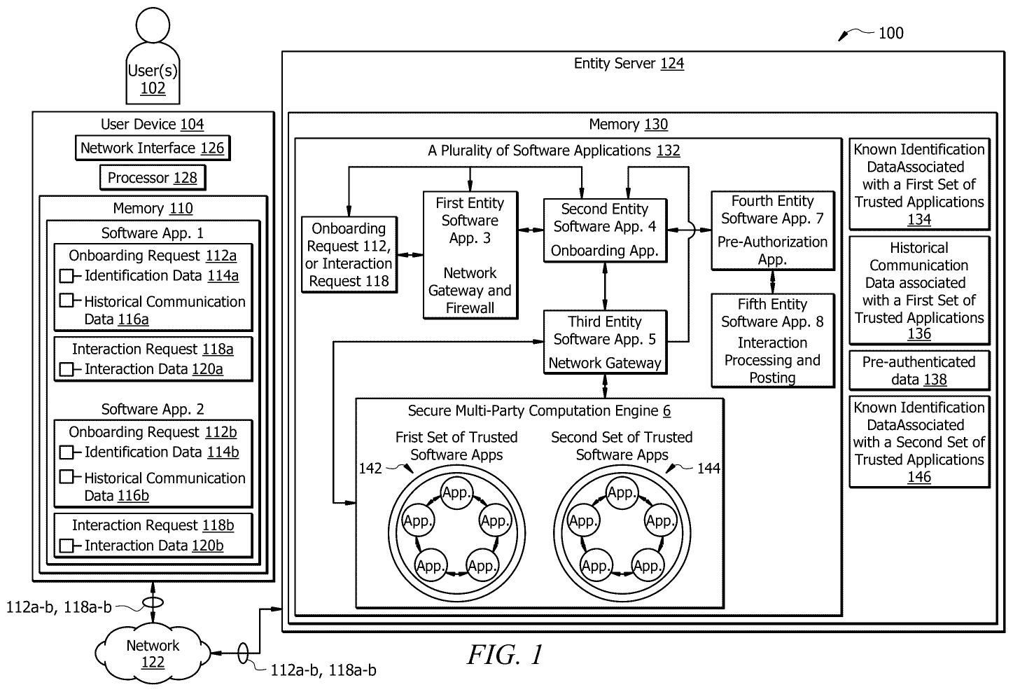

FIG. 1 illustrates a system 100 according to some embodiments of the present disclosure. In general, the system 100 includes a user device 104 operable to interact with one or more users 102, a network 122, and an entity server 124. In general, the entity server 124 may receive an onboarding request 112 from a first software application 1 associated with the user device 104. In some embodiments, the onboarding request 112a includes a request to communicate between the first software application 1 and a plurality of software applications 132 associated with the entity server 124. In some embodiments, the onboarding request 112a includes identification data 114a associated with the first software application 1 and historical communication data associated with the first software application 1. The entity server 124 is configured to determine whether the first software application 1 has previously been onboarded (e.g., approved to communicate) with the plurality of software applications 132 by comparing the identification data 114a associated with the first software application 1 to known identification data 134 associated with the first set of trusted software applications 142.

If the identification data 114a associated with the first software application 1 matches known identification data 134 associated with one or more trusted software application in the first set of trusted software applications 142, the entity server 124 determines that the first software application 1 has previously been onboarded and allowed to communicate with the plurality of software applications 132. In response, the entity server 124 allows the first software application 1 to communicate an interaction request 118a to the entity server 124 for processing and posting. In response to determining that the first software application 1 has not been previously approved to communicate with the plurality of software applications 132, the entity server 124 is configured to determine whether the first software application 1 has previously communicated with one or more of the first set of trusted software applications 142 by comparing the historical communication data 116a associated with the first software application 1 to the historical communication data associated with one or more of the first set of trusted software applications 142. In response to determining that the first software application 1 has previously communicated with one or more of the first set of trusted software applications 142, the entity server 124 is configured to pre-authenticate the first software application 1 to allow the first software application 1 to communicate an interaction request 118 to the plurality of software applications 132. The interaction request 118a may comprise interaction data 120a. The entity server 124 is configured to process the interaction data 120 using the plurality of software applications 132 to generate pre-authenticated data 138. The entity server 124 is further configured to store the pre-authenticated data 138 in the memory 130. In some embodiments, in response to receiving an indication that the first software application 1 is onboarded, the entity server 124 may process the pre-authenticated data 138 to post the interaction request 118a.

### System Components of FIG. 1

### User Device

User device 104 is generally any device configured to interact with one or more users 102. The user device 104 may be a mobile phone, a smartphone, an electronic tablet device, or a computer (e.g., personal computer, desktop, workstation, laptop). In some embodiments, the user device 104 is in signal communication with the entity server 124 via the network 122. The user device 104 may include one or more software applications, such as a first software application 1, a second software application 2, or any number of software applications. Each of the software applications 1-2 may be configured to send an onboarding request 112a-b to the entity server 124. As used herein, the term “onboarding” may refer to a process where the entity server 124 approves the software applications 1-2 to communicate an interaction request 118a-b comprising interaction data 120a-b to the entity server 124. The onboarding process may include various operations performed by the entity server 124 before allowing the software applications 1-2 to communicate the interaction data 120a-b to the entity server 124 and a plurality of software applications 132 within the entity server 124. For example, the onboarding process may include, but is not limited to, validating the identity of the user device 104 or the software applications 1-2, verifying contact information of a user 102 associated with the user device or software applications (e.g., address, phone numbers, etc.), establishing a payment method (e.g., processing account numbers and routing numbers to establish a payment method), and performing security checks (e.g., firewall to detect malware, etc.). In some embodiments, onboarding a user device 104 or software applications 1-2 takes time to be completed, and one or more operations in the onboarding process may include a manual review from a user in the entity server 124 or verification from one or more third parties before the user device 104 or the software applications 1-2 are approved to communicate with the entity server 124.

In some embodiments, the onboarding request 112a-b may comprise identification data 114a-b associated with the respective software application 1-2. In some embodiments, the identification data 114a-b may include, but is not limited to, an IP address associated with the user device 104, a MAC address associated with the user device 104, a legal name associated with a business operating the user device 104, a digital certificate or token associated with the software applications 1-2. In some embodiments, the onboarding request 112a-b may comprise historical communication data 116a-b associated with the software applications 1-2 or the user device 104. For example, the historical communication data 116a-b may comprise a data log that includes identification data of software applications, devices, networks, and/or servers that the software applications 1-2 or the user device 104 has previously communicated with in the past.

In some embodiments, the interaction request 118a-b comprises interaction data 120a-b. The interaction data 120a-b may be populated by the one or more users 102 to generate the interaction request 118a-b. In one particular embodiment, the interaction request 118a-b may a comprise a transaction request, such as a request to sell a new customer product, which may be in a new location. In a particular embodiment, the interaction data 114 comprises an invoice for a transaction, a request to fulfill a customer product, or the like.

The user device 104 may include a network interface 106, a processor 108, and a memory 110. The network interface 106 is configured to enable wired and/or wireless communications between the network 122 and the user device 104, as well as other components in the system 100. Suitable network interfaces 106 include an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The network interface 106 may be configured to use any suitable type of communication protocol as would be appreciated by one of ordinary skill in the art.

The memory 110 may be volatile or non-volatile and may comprise read-only memory (ROM), random-access memory (RAM), ternary content-addressable memory (TCAM), dynamic random-access memory (DRAM), and static random-access memory (SRAM). The memory 110 may include one or more of a local database, cloud database, network-attached storage (NAS), etc. The memory 110 comprises one or more disks, tape drives, or solid-state drives, and may be used as an over-flow data storage device, to store programs when such programs are selected for execution, and to store instructions and data that are read during program execution. The memory 110 may store the software applications 1-2, which may also comprise the onboarding request 112a-b and the interaction request 118a-b, along with any other data, instructions, logic, rules, or code operable to implement the function(s) described herein when executed by processor 108.

In one non-limiting example, the interaction request 118a-b may be a request from the user device 104 or software applications 1-2 to the entity server 124 to process an invoice to pay a vender. In this example, the interaction data 114 may comprise the invoice having a payload. The payload of the invoice may have a header amount and a plurality of line items associated with the transaction. The line items in the interaction data may include, but is not limited to, numerical values, free text describing the transaction, images, source code, or combinations thereof. The entity server 124 may validate the interaction data 120a-b prior to recording and processing the interaction request 118a-b. In another non-limiting example, the interaction request 118a-b may be a request by the user device 104 or software applications 1-2 to sell a new customer product, or an existing customer product in a new location. For example, the customer product may currently be sold in a first location (e.g., North Carolina) and the interaction request 118a-b may be requesting to sell the customer product in a second location (e.g., South Carolina). In this example, the interaction data 120a-b may include numerical values associated with the cost and specifications of the customer product, free text describing the customer product, images of the product, source code associated with the product, information associated with the company selling the product in the first jurisdiction, and information associated with the company selling the product in the second jurisdiction. In this example, the entity server 124 may audit the interaction data 114 to verify that the company in the second jurisdiction is associated with the company in the first jurisdiction (e.g., verify the company is a child company and is an active company that exists in South Carolina before processing the interaction).

The processor 108 of the user device 104 is configured to send the onboarding request 112a-b to the entity server 124 via the network 122 to process the identification data 114a-b and the historical communication data 116a-b. The processor 108 is also configured to send the interaction request 118a-b to the entity server 124 via the network 122 to process the interaction data 120a-b.

The processor 108 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, the processor 108 may be implemented in cloud devices, servers, virtual machines, and the like. The processor 108 may be a programmable logic device, a microcontroller, a microprocessor, or any suitable combination of the preceding. The processor 108 is configured to process data and may be implemented in hardware or software. For example, the processor 108 may be 8-bit, 16-bit, 32-bit, 64-bit, or of any other suitable architecture. The processor 108 may include an arithmetic logic unit (ALU) for performing arithmetic and logic operations, registers the supply operands to the ALU and store the results of ALU operations, and a control unit that fetches instructions from memory 110 and executes them by directing the coordinated operations of the ALU, registers and other components. The processor 108 is configured to implement various instructions described herein. For example, the processor 108 is configured to execute instructions from the memory 110 to implement the functions of the processor 108. In this way, processor 108 may be a special-purpose computer designed to implement the functions disclosed herein. In an embodiment, the processor 108 is implemented using logic units, FPGAs, ASICs, DSPs, or any other suitable hardware.

### Network

Network 122 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 122 may be configured to support any suitable type of communication protocol as would be appreciated by one of ordinary skill in the art. In some embodiments, the network 122 facilitates the transfer of data between the user device 104 and the entity server 124.

### Entity Server

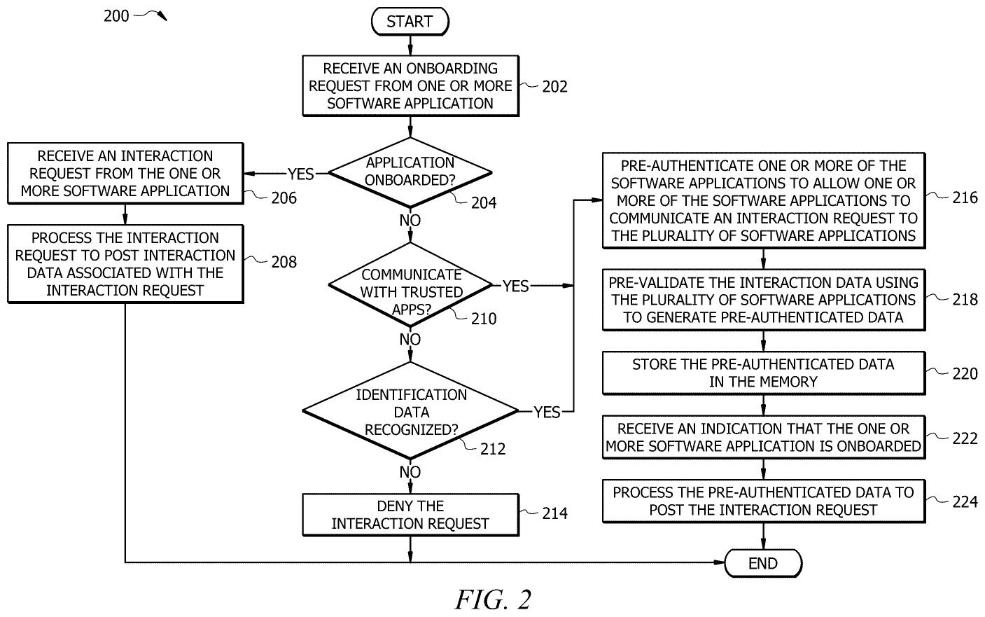

The entity server 124 comprises a processor 128 operably coupled with a network interface 126 and a memory 130. The processor 128 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 128 may be a programmable logic device, a microcontroller, a microprocessor, or any suitable number and combination of the preceding. The one or more processors are configured to process data and may be implemented in hardware or software. For example, the processor 128 may be 8-bit, 16-bit, 32-bit, 64-bit, or of any other suitable architecture. The processor 128 may include an arithmetic logic unit (ALU) for performing arithmetic and logic operations. The processor 128 may register the supply operands to the ALU and store the results of ALU operations. The processor 128 may further include a control unit that fetches instructions from memory and executes them by directing the coordinated operations of the ALU, registers, and other components. The one or more processors are configured to implement various software instructions. In this way, processor 128 may be a special-purpose computer designed to implement the functions disclosed herein. In an embodiment, the processor 128 is implemented using logic units, FPGAs, ASICs, DSPs, or any other suitable hardware. The processor 128 is configured to operate as described in FIGS. 1-2. For example, the processor 128 may be configured to perform one or more operations of the operational flow 200 as described in FIG. 2.

The network interface 126 is configured to enable wired and/or wireless communications between the entity server 124, the network 122, and the user device 104. Suitable network interfaces 126 include an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The network interface 126 may be configured to use any suitable type of communication protocol as would be appreciated by one of ordinary skill in the art.

The memory 130 may be volatile or non-volatile and may comprise read-only memory (ROM), random-access memory (RAM), ternary content-addressable memory (TCAM), dynamic random-access memory (DRAM), and static random-access memory (SRAM). The memory 130 may include one or more of a local database, cloud database, network-attached storage (NAS), etc. The memory 130 comprises one or more disks, tape drives, or solid-state drives, and may be used as an over-flow data storage device, to store programs when such programs are selected for execution, and to store instructions and data that are read during program execution. The memory 130 may comprise non-transitory computer-readable medium. The memory 130 may store any of the information described in FIGS. 1-2 along with any other data, instructions, logic, rules, or code operable to implement the function(s) described herein when executed by processor 128.

The memory 130 may be operable to store a plurality of software applications 132 that are configured to manage and process the onboarding request 112a-b and the interaction request 118a-b. In some embodiments, the plurality of software applications 132 may include, but are not limited to, a first entity software application 3 that includes a network gateway and firewall, a second entity software application 4 that includes an onboarding application, a third entity software application 5 that includes a network gateway, a secure multi-party computation engine 6 that includes a first set of trusted software applications 142 and a second set of trusted software applications 144, a fourth entity software application 7 that includes a pre-authentication application, and a fifth entity software application 8 that includes an interaction processing and posting application. The plurality of software applications 132 will be described in greater detail with reference to FIG. 2. The memory 130 is further operable to store known identification data 134 associated with the first set of trusted software applications 142, known historical communication data 136 associated with a first set of trusted software applications 142, pre-authenticated data 138, and known identification data 146 associated with the second set of trusted software applications 144.

### Example Operation

FIG. 2 illustrates an operational flow 200 according to one embodiment of the present disclosure. The operational flow 200 can logically be described in three parts. The first part includes operations 202-208, which generally includes receiving one or more onboarding request 112a-b from one or more software applications 1-2 and determining whether the one or more software applications 1-2 has previously been onboarded and therefore approved to communicate with the plurality of software applications 132 in the entity server 124. To determine whether the one or more software applications 1-2 has previously been onboarded, the entity server 124 may compare the identification data 114a-b associated with the one or more software applications 1-2 to the known identification data 134 associated with the first set of trusted software applications 142. If the identification data 114a-b associated with the one or more software applications 1-2 matches the known identification data 134 associated with the one or more of the first set of trusted software applications 142, then the operational flow 200 may determine that the one or more software applications 1-2 are onboarded, and may authorize the one or more software applications 1-2 to communicate an interaction request 118a-b to the entity server 124. The entity server 124 may then process the interaction request 118a-b to post the interaction data 120a-b, as will be detailed further below. If the entity server 124 determines that the identification data 114a-b does not match the known identification data 134 associated with the one or more of the first set of trusted software applications 142, then the operational flow 200 may proceed to the second part of the operational flow 200.

The second part of the operational flow 200 includes operations 210-214, which includes determining whether one or more of the software applications 1-2 has previously communicated with one or more of the first set of trusted software applications 142 by comparing the historical communication data 116a-b associated with one or more of the software applications 1-2 to the known historical communication data 136 associated with one or more of the first set of trusted software applications 142. If the entity server 124 determines that one or more of the software applications 1-2 has previously communicated with one or more of the first set of trusted software applications 142, the operational flow 200 proceeds to the third part, which will be described below. If the entity server 124 determines that one or more of the software applications 1-2 has not previously communicated with one or more of the first set of trusted software applications 142, the operational flow 200 continues with the second part and the entity server 124 determines whether the identification data 114a-b associated with one or more of the software applications 1-2 matches the known identification data 146 associated with one or more of the second set of trusted software applications 144. If the identification data 114a-b associated with one or more of the software applications 1-2 matches the known identification data 146 associated with one or more of the second set of trusted software applications 144, the operational flow 200 proceeds to the third part, which will be detailed below. If the identification data 114a-b associated with one or more of the software applications 1-2 does not match the known identification data 146 associated with one or more of the second set of trusted software applications 144, the operational flow 200 proceeds to deny the interaction request 118a-b.

The third part of the operational flow 200 includes operations 216-224. As noted above, if the entity server 124 determines that one or more of the software applications 1-2 has previously communicated with one or more of the first set of trusted software applications 142 or if the entity server 124 determines that the identification data 114a-b associated with one or more of the software applications 1-2 matches the known identification data 146 associated with one or more of the second set of trusted software applications 144, the operational flow 200 proceeds to the third part. In response to either condition above, the third part of the operational flow 200 includes pre-authenticating one or more of the software applications 1-2 to allow one or more of the software applications 1-2 to communicate the interaction request 118a-b to the plurality of software applications 132 in the entity server 124. The third part of operational flow 200 further includes processing the interaction data 120a-b using the plurality of software applications 132 in the entity server 124 to generate pre-authenticated data 138, and storing the pre-authenticated data 138 in the memory 130. The third part of the operational flow 200 may further include receiving an indication that one or more of the software applications 1-2 is onboarded, and in response to receiving the indication that one or more of the software applications 1-2 are onboarded, process the pre-authenticated data 138 to post the interaction data 120a-b of the interaction request 118a-b.

At operation 202, the operational flow 200 includes receiving an onboarding request 112a-b on the entity server 124 from one or more of the software applications 1-2. For example, the entity server 124 may receive a first onboarding request 112a from a first software application 1 and/or a second onboarding request 112b from a second software application 2. In some embodiments, the onboarding request 112a-b comprises identification data 114a-b associated with one or more of the software applications 1-2 and historical communication data 116a-b associated with one or more of the software applications 1-2. In some non-limiting examples, the identification data 114a-b may include, but is not limited to, an IP address associated with the user device 104, a MAC address associated with the user device 104, a legal name associated with a business operating the user device 104, a digital certificate or token associated with the software applications 1-2. In some non-limiting examples, the historical communication data 116a-b may comprise a data log that includes identification data of software applications, devices, networks, and/or servers that the software applications 1-2 has previously communicated with in the past.

In some embodiments, the plurality of software applications 132 of the entity server 124 are configured to receive the onboarding request 112a-b. For example, at operation 202, a first entity software application 3 may be configured to receive the onboarding request 112a-b and initiate processing of the onboarding request 112a-b. In some embodiments, the first entity software application 3 comprises a firewall operating according to a defined set of rules and/or security thresholds that permit or deny certain types of data to flow into the entity server 124. The rules are configured to allow desirable data to flow between the entity server 124 and the network 122, and the rules may exclude any network traffic that may pose a security threat to the entity server 124. Examples of data that should be excluded includes malware, viruses, worms, malicious code, certain cookies, spam, blocked websites, and the like. The first entity software application 3 may include a firewall that includes, but is not limited to, packet filters, circuit-level gateways, application layer filters, a stateful inspection firewall, or next-generation firewall. The first entity software application 3 may also include a network gateway configured that is configured to route the onboarding request 112a-b to the second entity software application 4 after passing through the firewall.

At decision block 204, the operational flow 200 includes determining whether one or more of the software applications 1-2 has previously been onboarded and therefore approved to communicate with the plurality of software applications 132 by comparing the identification data 114a-b associated with one or more of the software application 1-2 to the known identification data 134 associated with the first set of trusted software applications 142. For example, decision block 204 may include comparing a digital certificate or token associated with a first software application 1 to a digital certificate or token associated one or more trusted software application in the first set of trusted software applications 142. If the identification data 114a of the first software application 1 matches the known identification data 134 associated with one or more trusted software application in the first set of trusted software applications 142, the entity server 124 may determine that the first software application 1 has previously been onboarded and is therefore trustworthy. The operations in decision block 204 may be performed by the second entity software application 4, which may include an onboarding application configured to perform the aforementioned operations. If the entity server 124 determines that the identification data 114a-b associated with one or more of the software applications 1-2 matches the known identification data 134 associated with one or more trusted software application in the first set of trusted software applications 142, the operational flow proceeds to operation 206. If the entity server 124 determines that the identification data 114a-b associated with one or more of the software applications 1-2 does not match the known identification data 134 associated with one or more trusted software application in the first set of trusted software applications 142, the operational flow 200 proceeds to decision block 210.

In response to determining that the identification data 114a-b associated with one or more of the software applications 1-2 matches the known identification data 134 associated with one or more trusted software application in the first set of trusted software applications 142, the operational flow 200 proceeds to operation 206. For example, since the identification data 114a-b is recognized by the entity server 124, the entity server 124 may deem the software applications 1-2 trustworthy since the software applications 1-2 have previously been onboarded due to matching one or more trusted software application in the first set of trusted software applications 142, and may authorize the software applications 1-2 to communicate the interaction request 118a-118 to the entity server 124. For example, at operation 206, the second entity software application 4 may generate an indication that one or more of the software applications 1-2 have been previously onboarded, and the entity server 124 may approve one or more of the software applications 1-2 to send the interaction request 118a-b to the entity server 124. The first entity software application 3 may route the interaction request 118a-b to the fifth software application 8, which performs operation 208.

At operation 208, the operational flow 200 may process the interaction request 118a-b to post interaction data 120a-b associated with the interaction request 118a-b. In some embodiments, processing and posting the interaction data 120a-b includes several operations performed by the fifth software application 8, which may include, but are not limited to, validating an identity of a company or vender associated with the interaction data 120a-b, performing data enrichment operations to the interaction data 120a-b (e.g., process the line-items in an invoice to interpret source code associated with the line-items, process the line-items and header to determine the type of interaction data 120a-b and any account number associated with the interaction data 120a-b), performing middleware operations (e.g., process the interaction data 120a-b to identify information to perform the interaction and remove any information not associated with the interaction), final validations (e.g., process the interaction data 120a-b to confirm the line-items, identify and remove duplicate information in the interaction data 120a-b, and validate source code in the interaction data 120a-b), and posting the interaction data 120a-b (e.g., process the payment of the invoice, process a payment associated with the new customer product, or approve the audit of the new customer product).

Referring back to decision block 204, in response to determining that the identification data 114a-b associated with one or more of the software applications 1-2 does not match the known identification data 134 associated with one or more trusted software application in the first set of trusted software applications 142, the operational flow 200 proceeds to decision block 210. At decision block 210, the operational flow 200 includes determining whether one or more of the software applications 1-2 has previously communicated with one or more trusted software application in the first set of trusted software applications 142. For example, the entity server 124 may compare the historical communication data 116a-b associated with one or more of the software applications 1-2 to the known historical communication data 136 associated with one or more trusted software application in the first set of trusted software applications 142. For example, the historical communication data 116a-b may include data that indicates one or more of the software applications 1-2 have communicated with an IP address, MAC address, digital certificate or token that is associated with a trusted software application in the first set of trusted software applications 142. Additionally or alternatively, the known historical communication data 136 may include data that indicates one or more trusted software application in the first set of trusted software applications 142 have communicated with an IP address, MAC address, digital certificate or token that is associated with one or more of the software applications 1-2. If one or more of the software applications 1-2 has communicated with one or more trusted software application in the first set of trusted software applications 142, the operational flow 200 proceeds to operation 216. If one or more of the software applications 1-2 has not communicated with one or more trusted software application in the first set of trusted software applications 142, the operational flow 200 proceeds to decision block 212.

In some embodiments, the operations in decision block 210 may be performed by the third entity software application 5 and the secure multi-party computation engine 6. The third entity software application 5 may include a network gateway that routes the onboarding request 112a-b from the second entity software application 4 to the secure multi-party computation engine 6. The secure multi-party computation engine 6 may include the first set of trusted software application 142 and is configured to perform a secure multi-party computation (SMPC) using a cryptographic protocol that is configured to encrypt the historical communication data 116a-b associated with the one or more software applications 1-2 and the known historical communication data 136 associated with one or more trusted software application in the first set of trusted software applications 142, such that data shared between the one or more software applications 1-2 and the first set of trusted software applications 142 is interpretable by the SMPC engine 6, but is uninterpretable by either the software applications 1-2 or the first set of trusted software applications 142. That is, the SMPC engine 6 may perform the comparison on the encrypted data without sharing the data or information with the software applications 1-2 or the first set of trusted software applications 142.

If one or more of the software applications 1-2 has not communicated with one or more trusted software application in the first set of trusted software applications 142, the operational flow 200 proceeds to decision block 212. At decision block 212, the operational flow 200 includes determining whether the identification data 114a-b associated with one or more of the software application 1-2 matches the known identification data 146 associated with one or more trusted software application in a second set of trusted software applications 144. For example, in certain instances, rather than providing a primary legal name associated with a business operating the user device 104 in the identification data 114a-b, a user 102 may provide a subsidiary legal name associated with a business operating the user device 104. In this example, the subsidiary legal name may not generate a match in decision block 204. That is, the known identification data 134 associated with the first set of trusted software applications 142 may include the primary legal name associated with the business operating the user device 104 and not the subsidiary legal name. However, the known identification data 146 associated with the second set of trusted software applications 144 may include the subsidiary name of the business operating the user device 104. In some embodiments, the entity server 124 communicates with a third-party service (not shown) to retrieve the known identification data 146 associated with the second set of trusted software applications 144. If the entity server 124 determines that the identification data 114a-b associated with one or more of the software applications 1-2 matches the known identification data 146 associated with one or more trusted software application in the second set of trusted software applications 144, the operational flow 200 proceeds to operation 216, which will be detailed below. If the entity server 124 determines that the identification data 114a-b associated with one or more of the software applications 1-2 does not match the known identification data 146 associated with one or more trusted software application in the second set of trusted software applications 144, the operational flow proceeds to operation 214, which includes denying the onboarding request 112a-b.

In some embodiments, the operations in decision block 212 and operation 214 are performed by the SMPC engine 6. For example, the SMPC engine 6 may include the second set of trusted software applications 144. Alternatively, the SMPC engine 6 may communicate with a third-party service (not shown) to receive data associated with the second det of trusted software applications 144. Similar to above, the SMPC engine 6 may perform the cryptographic protocol that is configured to encrypt the identification data 114a-b associated with one or more of the software applications 1-2 and encrypt the known identification data 146 associated with one or more trusted software application in the second set of trusted software applications 144, such that data shared between the one or more software applications 1-2 and the second set of trusted software applications 144 is interpretable by the SMPC engine 6, but is uninterpretable by either the software applications 1-2 or the second set of trusted software applications 144. That is, the SMPC engine 6 may perform the comparison on the encrypted data without sharing the data or information with the software applications 1-2 or the second set of trusted software applications 144.

Referring back to decision block 210, in response to determining that one or more of the software applications 1-2 has communicated with one or more trusted software application in the first set of trusted software applications 142, the operational flow 200 proceeds to operation 216. At operation 216, the entity server 124 is configured to pre-authenticate one or more of the software applications 1-2 to allow one or more of the software applications 1-2 to communicate the interaction request 118a to the plurality of software applications 132. In some embodiments, the pre-authentication occurs before the second entity software application 4 receives an indication that one or more of the software applications are onboarded. In some embodiments, the first entity software application 3 receives the interaction request 118a-b and routes the interaction request 118a-b to the fourth entity software application 7 which includes a pre-authentication application.

At operation 218, the operational flow 200 includes processing the interaction data 120a-b using the pre-authentication application in the fourth entity software application 7 to generate pre-authenticated data 138. In some embodiments, the fourth entity software application 7 may perform various operations to generate the pre-authenticated data 138. For example, the operations performed by the fourth entity software application 7 may include, but are not limited to, validating an identity of a company or vender associated with the interaction data 120a-b, performing data enrichment operations to the interaction data 120a-b (e.g., process the line-items in an invoice to interpret source code associated with the line-items, process the line-items and header to determine the type of interaction data 120a-b and any account number associated with the interaction data 120a-b), performing middleware operations (e.g., process the interaction data 120a-b to identify information to perform the interaction and remove any information not associated with the interaction), final validations (e.g., process the interaction data 120a-b to confirm the line-items, identify and remove duplicate information in the interaction data 120a-b, and validate source code in the interaction data 120a-b). At operation 220, the operational flow 200 includes storing the pre-authenticated data 138 in the memory 130, which may be in a pre-authenticated area in the pre-authenticated application.

At operation 222, the entity server 124 may receive an indication that one or more of the software applications 1-2 are onboarded. As discussed above, some operations in the onboarding process may include manual operations performed by a user, which may take time to be completed. The entity server 124 may receive the indication from the user once the manual operations are completed. In response to receiving the indication that the one or more software applications 1-2 are onboarded, the operational flow 200 proceeds to operation 224. At operation 224 the operational flow includes processing the pre-authenticated data 138 to post the interaction request 118a-b. In some embodiments, posting the pre-authenticated data 138 includes processing the payment of the invoice, processing a payment associated with the new customer product, or approving the audit of the new customer product.

While several embodiments have been provided in the present disclosure, it should be understood that the disclosed system and method might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, system, subsystem, and method described and illustrated in the various embodiments as discrete or separate may be combined or integrated with other system, modules, techniques, or method without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A system comprising:
a memory operable to store:
a plurality of software applications configured to manage interaction data;
known identification data associated with a first set of trusted software applications that are approved to communicate with the plurality of software applications;
historical communication data associated with the first set of trusted software applications;
a processor operably coupled to the memory, the processor configured to:
receive an onboarding request from a first software application, wherein the onboarding request includes a request to communicate between the first software application and the plurality of software applications, wherein the onboarding request comprises:
identification data associated with the first software application; and
historical communication data associated with the first software application;
determine whether the first software application has previously been approved to communicate with the plurality of software applications by comparing the identification data associated with the first software application to the known identification data associated with the first set of trusted software applications;
in response to determining that the first software application has not been previously approved to communicate with the plurality of software applications, the processor is configured to determine whether the first software application has previously communicated with one or more of the first set of trusted software applications by comparing the historical communication data associated with the first software application to the historical communication data associated with one or more of the first set of trusted software applications;
in response to determining that the first software application has previously communicated with one or more of the first set of trusted software applications, the processor is configured to pre-authenticate the first software application to allow the first software application to communicate an interaction request to the plurality of software applications, wherein the interaction request comprises the interaction data;
process the interaction data using the plurality of software applications to generate pre-authenticated data; and
store the pre-authenticated data in the memory.

2. The system of claim 1, wherein the processor is further configured to:
receive an indication that the first software application is onboarded; and
in response to receiving the indication that the first software application is onboarded, process the pre-authenticated data to post the interaction request.

3. The system of claim 1, wherein the memory is further operable to store known identification data associated with a second set of trusted software applications; and
wherein the processor is further configured to:
in response to determining that the first software application has not previously communicated with one or more of the first set of trusted software applications, the processor is configured to determine whether the identification data associated with the first software application matches the known identification data associated with one or more of the second set of trusted software applications; and
in response to determining that the identification data associated with the first software application matches the known identification data associated with one or more of the second set of trusted software applications, the processor is configured to pre-authenticate the first software application to allow the first software application to communicate the interaction request to the plurality of software applications.

4. The system of claim 3, wherein in response to determining that the first software application does not match the known identification data associated with one or more of the second set of trusted software applications, the processor is configured to deny the onboarding request.

5. The system of claim 1, wherein the processor is further configured to:
compare the historical communication data associated with the first software application to the historical communication data associated with one or more of the first set of trusted software applications using a secure multi-party computation protocol.

6. The system of claim 1, wherein the processor is further configured to:
receive a second onboarding request for a second software application, wherein the second onboarding request includes a second request to communicate between the second software application and the plurality of software applications, wherein the second onboarding request comprises second identification data associated with the second software application;
determine whether the second software application has previously been approved to communicate with the plurality of software applications by comparing the second identification data associated with the second software application to the known identification data associated with the first set of trusted software applications;
in response to determining that the second software application is approved to communicate with the plurality of software applications, the processor is further configured to receive a second interaction request from the second software application, wherein the second interaction request comprises second interaction data; and
process the second interaction data to post the second interaction request.

7. The system of claim 1, wherein the plurality of software applications comprise a pre-authentication application, wherein the pre-authentication application is configured to generate the pre-authenticated data; and
wherein the processor is further configured to store the pre-authenticated data in a pre-authenticated area in the pre-authentication application.

8. A method comprising:
receiving, on an entity server, an onboarding request from a first software application, wherein the onboarding request includes a request to communicate between the first software application and a plurality of software applications, wherein the onboarding request comprises:
identification data associated with the first software application; and
historical communication data associated with the first software application;
determining whether the first software application has previously been approved to communicate with the plurality of software applications configured to manage interaction data by comparing the identification data associated with the first software application to known identification data associated with a first set of trusted software applications;
in response to determining that the first software application has not been previously approved to communicate with the plurality of software applications, the method further comprises determining whether the first software application has previously communicated with one or more of the first set of trusted software applications by comparing the historical communication data associated with the first software application to the historical communication data associated with one or more of the first set of trusted software applications;
in response to determining that the first software application has previously communicated with one or more of the first set of trusted software applications, the method further comprises pre-authenticating the first software application to allow the first software application to communicate an interaction request to the plurality of software applications, wherein the interaction request comprises the interaction data;
processing the interaction data using the plurality of software applications to generate pre-authenticated data; and
storing the pre-authenticated data in a memory.

9. The method of claim 8, wherein the method further comprises:
receiving an indication that the first software application is onboarded; and
in response to receiving the indication that the first software application is onboarded, processing the pre-authenticated data to post the interaction request.

10. The method of claim 8 further comprising:
in response to determining that the first software application has not previously communicated with one or more of the first set of trusted software applications, the method further comprises determining whether the identification data associated with the first software application matches known identification data associated with one or more of a second set of trusted software applications; and
in response to determining that the identification data associated with the first software application matches the known identification data associated with one or more of the second set of trusted software applications, the method further comprises pre-authenticating the first software application to allow the first software application to communicate the interaction request to the plurality of software applications.

11. The method of claim 10, wherein in response to determining that the first software application does not match the known identification data associated with one or more of the second set of trusted software applications, the method further comprises denying the onboarding request.

12. The method of claim 8 further comprising:
comparing the historical communication data associated with the first software application to the historical communication data associated with one or more of the first set of trusted software applications using a secure multi-party computation protocol.

13. The method of claim 8 further comprising:
receiving, on the entity server, a second onboarding request for a second software application, wherein the second onboarding request includes a second request to communicate between the second software application and the plurality of software applications, wherein the second onboarding request comprises second identification data associated with the second software application;
determining whether the second software application has previously been approved to communicate with the plurality of software applications by comparing the second identification data associated with the second software application to the known identification data associated with the first set of trusted software applications;
in response to determining that the second software application is approved to communicate with the plurality of software applications, the method further comprises receiving a second interaction request from the second software application, wherein the second interaction request comprises second interaction data; and
processing the second interaction data to post the second interaction request.

14. The method of claim 8, wherein the plurality of software applications comprise a pre-authentication application, wherein the pre-authentication application is configured to generate the pre-authenticated data; and
wherein the method further comprises storing the pre-authenticated data in a pre-authenticated area in the pre-authentication application.

15. A non-transitory computer-readable medium that stores instructions that when executed by a processor, cause the processor to:
receive an onboarding request from a first software application, wherein the onboarding request includes a request to communicate between the first software application and a plurality of software applications, wherein the onboarding request comprises:
identification data associated with the first software application; and
historical communication data associated with the first software application;
determine whether the first software application has previously been approved to communicate with the plurality of software applications by comparing the identification data associated with the first software application to known identification data associated with a first set of trusted software applications;
in response to determining that the first software application has not been previously approved to communicate with the plurality of software applications, the processor is configured to determine whether the first software application has previously communicated with one or more of the first set of trusted software applications by comparing the historical communication data associated with the first software application to historical communication data associated with one or more of the first set of trusted software applications;
in response to determining that the first software application has previously communicated with one or more of the first set of trusted software applications, the processor is configured to pre-authenticate the first software application to allow the first software application to communicate an interaction request to the plurality of software applications, wherein the interaction request comprises interaction data;
process the interaction data using the plurality of software applications to generate pre-authenticated data; and
store the pre-authenticated data in a memory.

16. The non-transitory computer-readable medium of claim 15, wherein the instructions when executed by the processor further cause the processor to:
receive an indication that the first software application is onboarded; and
in response to receiving the indication that the first software application is onboarded, process the pre-authenticated data to post the onboarding request.

17. The non-transitory computer-readable medium of claim 15, wherein the instructions when executed by the processor further cause the processor to:
in response to determining that the first software application has not previously communicated with one or more of the first set of trusted software applications, the processor is configured to determine whether the identification data associated with the first software application matches known identification data associated with one or more of a second set of trusted software applications; and
in response to determining that the identification data associated with the first software application matches the known identification data associated with one or more of the second set of trusted software applications, the processor is configured to pre-authenticate the first software application to allow the first software application to communicate the interaction request to the plurality of software applications.

18. The non-transitory computer-readable medium of claim 17, wherein the instructions when executed by the processor further cause the processor to:
in response to determining that the first software application does not match the known identification data associated with one or more of a second set of software applications, the processor is configured to deny the interaction request.

19. The non-transitory computer-readable medium of claim 15, wherein the instructions when executed by the processor further cause the processor to:
compare the historical communication data associated with the first software application to the historical communication data associated with one or more of the first set of trusted software applications using a secure multi-party computation protocol.

20. The non-transitory computer-readable medium of claim 15, wherein the plurality of software applications comprise a pre-authentication application, wherein the pre-authentication application is configured t to generate the pre-authenticated data; and
wherein the instructions when executed by the processor further cause the processor to store the pre-authenticated data in a pre-authenticated area in the pre-authentication application.
